(19) United States
(12) Patent Application Publication
(10) Pub. No.: US 2009/0232593 A1
(43) Pub. Date: Sep. 17, 2009

(54) BAMBOO FRAME STRUCTURE

(76) Inventor: Wen-Tsan Wang, Taipei City (TW)

Correspondence Address: LEONG C LEI, PMB # 1008, 1867 YGNACIO VALLEY ROAD, WALNUT CREEK, CA, 94598, US

(21) Appl. No.: 12/048,228

(22) Filed: Mar. 14, 2008

(51) Int. Cl. F16B 7/18

(52) U.S. Cl. 403/341; 403/376

(57) ABSTRACT

A bamboo frame structure formed of female bamboo frame bars and male bamboo frame bars and reinforced with reinforcing bamboo strips is disclosed. Each female bamboo frame bar is formed of two parallel bamboo strips and a plurality of transverse bamboo blocks set in between the two parallel bamboo strips and kept apart from one another at a distance and kept spaced from the two distal ends each bamboo strip at a distance. Each male bamboo frame is formed of two parallel bamboo strips and a plurality of longitudinal bamboo blocks set in between the two bamboo strips and respectively protruding over the two distal ends of each bamboo strip in such a manner that the protruding part of each bamboo block at one end of each male bamboo frame bar is tightly insertable into the gap in between the two bamboo strips of each female bamboo frame bar and connectable thereto with a fastening member.

### BACKGROUND OF THE INVENTION

(a) Technical Field of the Invention

The present invention relates to bamboo materials and more particularly, to a bamboo frame structure for making bamboo cabinets, bamboo racks, bamboo storage boxes and bamboo furniture.

(b) Description of the Prior Art

Various materials including ceramics, glass, wood, plastics, stainless steel, and etc. may be used for making storage containers for keeping things. Recently, bamboo materials are intensively used for making furniture for the advantage of causing a sense of antique beauty. A bamboo furniture has frame bars (posts and beams) prepared from bamboo. A bamboo frame bar may be prepared subject to one of the following two ways:

The first way is to cut well-dried bamboo canes into small bamboo strips, and then to bond a number of bamboo strips into a bamboo plate by means of a compression bonding process, and then cut the bamboo plate into the desired shape.

The second way is to crush bamboo canes into chips and then to mix the bamboo chips with an adhesive, and then to mold the mixture into a bamboo plate through a thermal compression molding process, and then to cut the bamboo plate into the desired shape.

According to the aforesaid prior art processing processes, the prepared bamboo frame bars may have to be covered with a wood grain covering. The cost of the aforesaid prior art processing processes is high. Further, the aforesaid prior art processing processes consume much energy. The use of the adhesive may cause environmental pollution.

### SUMMARY OF THE INVENTION

The primary purpose of the present invention is to provide well-dried bamboo canes are longitudinally cut into bamboo strips, and a part of the bamboo strips are cut into transverse and longitudinal bamboo blocks. The bamboo strips and the bamboo blocks may be bonded together to form female bamboo frame bars and female bamboo frame bars for making bamboo cabinets, bamboo racks, bamboo storage boxes and bamboo furniture.

A female bamboo frame bar can be formed of two bamboo strips and a number of transverse bamboo blocks. The bamboo strips are arranged in parallel, and the transverse bamboo blocks are set in between the two bamboo strips and kept part and spaced from the two distal ends of each bamboo strip at a distance so that a gap is defined in each end of the female bamboo frame bar between the two bamboo strips. A male bamboo frame bar can be formed of two bamboo strips and a number of longitudinal bamboo blocks. The bamboo strips are arranged in parallel, and the longitudinal bamboo blocks are set in between the two bamboo strips at the two distal ends and partially protruding over each end of the male bamboo frame bar. By means of inserting the protruding part of the longitudinal bamboo block of one male bamboo frame bar into the gap in one end of one female bamboo frame bar, one female bamboo frame bar and one male bamboo frame bar are connected at right angles to form an angle frame. Further, bamboo strips may be obliquely connected between the male bamboo frame bar and the female bamboo frame bar to reinforce the structural strength of the angle frame.

Further, a female bamboo frame bar can be formed of three or more bamboo strips with transverse bamboo blocks respectively set in between each two adjacent bamboo strips to keep the bamboo strips apart and in a parallel manner. A male bamboo frame bar can also be formed of three or more bamboo strips with longitudinal bamboo blocks respectively set in between each two adjacent bamboo strips at the two distal ends.

Further, one male bamboo frame bar and one female bamboo frame bar may be connected in a line, thereby forming a post.

Further, bamboo strips and bamboo blocks may be directly bonded together, forming a solid bamboo frame bar for use as a leg member for a bamboo furniture.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic drawing showing a well-dried bamboo cane cut in longitudinal direction according to the present invention.

FIG. 2 illustrates two bamboo strips cut from a bamboo cane according to the present invention.

FIG. 3 is an exploded view of a part of bamboo frame structure formed of female bamboo frame bars and male bamboo frame bars in accordance with a first embodiment of the present invention.

FIG. 4 is an exploded view of a bamboo post formed of one female bamboo frame bar and one male bamboo frame bar in accordance with a first embodiment of the present invention.

FIG. 5 is an exploded view of a part of bamboo frame structure formed of female bamboo frame bars and male bamboo frame bars in accordance with a second embodiment of the present invention.

FIG. 6 is an oblique elevation of a bamboo rack formed of female bamboo frame bars and male bamboo frame bars in accordance with the second embodiment of the present invention.

FIG. 7 is a schematic drawing showing a bamboo grating panel supported on two supports and each support formed of one female bamboo frame bar and one male bamboo frame bar in accordance with the second embodiment of the present invention.

FIG. 8 is a plain view of a rectangular open frame formed of female bamboo frame bars and male bamboo frame bars and reinforced with bamboo strips according to the present invention.

FIG. 9 is a schematic plain view showing an E-shaped frame formed of three male bamboo frame bars and one female bamboo frame bar and reinforced with reinforcing bamboo strips according to the present invention.

FIG. 10 is a schematic plain view showing an angle frame structure formed of two male bamboo frame bars and two female bamboo frame bars with bamboo blocks set between the two male bamboo frame bars and the two female bamboo frame bars according to the present invention.

FIG. 11 is a schematic plain view showing an angle frame structure formed of a male bamboo frame bar and a female bamboo frame bar with a reinforcing member obliquely connected between the female bamboo frame bar and the male bamboo frame bar according to the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

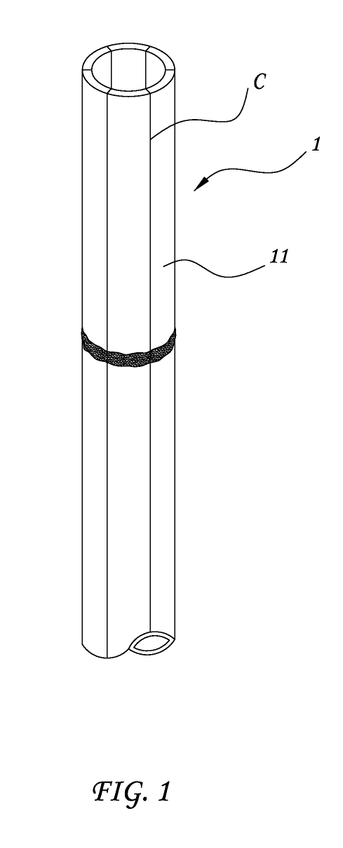

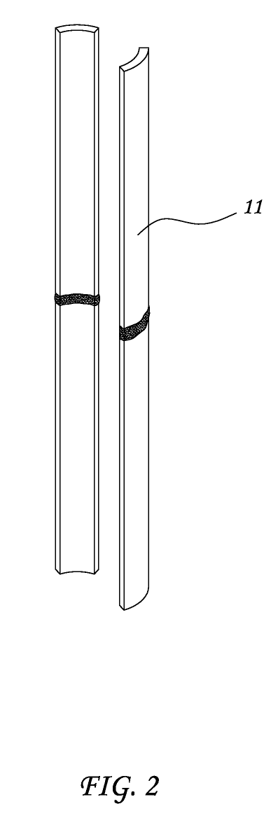

Referring to FIGS. 1 and 2, a well-dried bamboo cane 1 is trimmed and then cut along the length C into bamboo strips 11.

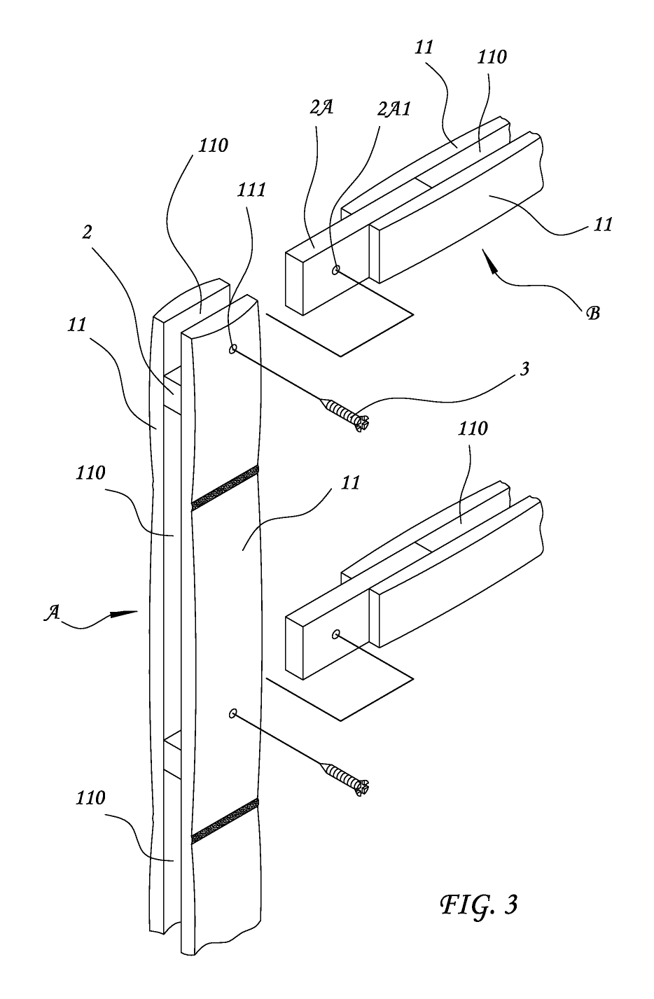

Referring to FIG. 3, each two bamboo strips 11 are connected in parallel with transverse bamboo blocks 2 set therebetween to form a respective female bamboo frame bar A. Alternatively, each two bamboo strips 11 can be connected in parallel with a longitudinal bamboo block 2A set therebetween at each of the two opposite ends to form a respective male bamboo frame bar B. The transverse bamboo blocks 2 and the longitudinal bamboo block 2A are respectively fastened to the respective bamboo strips 11 by means of an adhesive, pins, screws, or any of a variety of conventional bonding techniques. The transverse bamboo blocks 2 or longitudinal bamboo blocks 2A define a gap 110 between the two bamboo strips 11. The transverse bamboo blocks 2 are kept spaced from the ends of the female bamboo frame bar A at a distance. The longitudinal bamboo block 2A protrudes over the associating end of the associating male bamboo frame bar B for insertion into the gap 110 in between the two bamboo strips 1 of one female bamboo frame bar A. Mounting through holes 111 and 2A1 are transversely cut through the bamboo strips 11 of each female bamboo frame bar A and the longitudinal blocks 2A of each male bamboo frame bar B. When the protruding part of the longitudinal block 2A at one end of one male bamboo frame bar B is inserted into the gap 110 between the two longitudinal strips 11 of one female bamboo frame bar A, a fastening member, for example, screw 3 is fastened to the corresponding mounting through hole 111 at the female bamboo frame bar A and the mounting through hole 2A1 at the longitudinal block 2A to affix the female bamboo frame bar A and the male bamboo frame bar B at right angles. According to this embodiment, each female bamboo frame bar A is used as a post, and each male bamboo frame bar B is used as a beam.

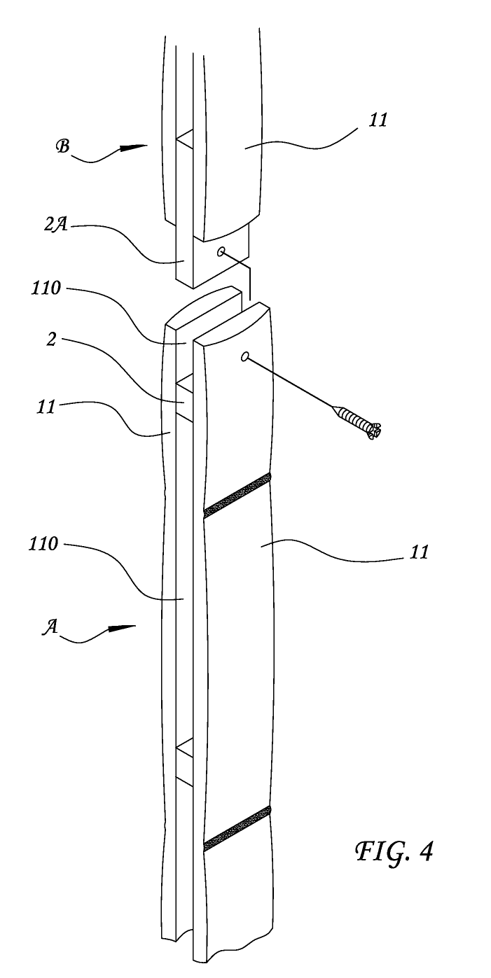

Referring to FIG. 4, one female bamboo frame bar A and one male bamboo frame bar B can be connected in line to form a bamboo post by means of inserting the protruding part of the protruding part of the longitudinal block 2A at one end of the male bamboo frame bar B into the gap 110 between the two longitudinal strips 11 of the female bamboo frame bar A and fixedly connected thereto with a fastening member, for example, screw.

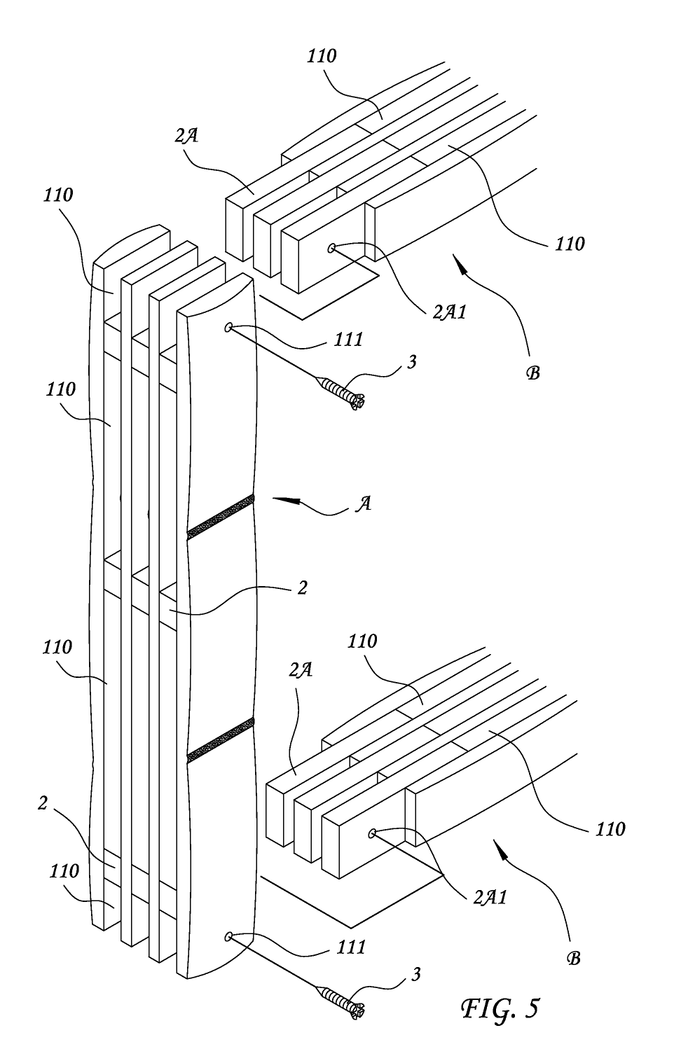

FIG. 5 is an exploded view of an alternate form of the present invention. According to this embodiment, each female bamboo frame bar A is comprised of a plurality of bamboo strips 11 arranged in parallel, and a plurality of transverse bamboo blocks 2 respectively set between each two adjacent bamboo strips 11; each male bamboo frame bar B is comprised of a plurality of bamboo strips 11 arranged in parallel, and a plurality of longitudinal bamboo blocks 2A respectively set between each two adjacent bamboo strips 11 at each of the two distal ends and respectively protruding over the associating end of the male bamboo frame bar B. Same as the embodiment shown in FIG. 3, mounting through holes 111 and 2A1 are transversely cut through the bamboo strips 11 of each female bamboo frame bar A and the longitudinal blocks 2A of each male bamboo frame bar B. When the longitudinal blocks 2A at one end of one male bamboo frame bar B are respectively inserted into the gaps 110 between each two adjacent longitudinal strips 11 of one female bamboo frame bar A, a fastening member, for example, screw 3 is fastened to the corresponding mounting through holes 111 at the female bamboo frame bar A and the mounting through holes 2A1 at the longitudinal block 2A to affix the female bamboo frame bar A and the male bamboo frame bar B at right angles.

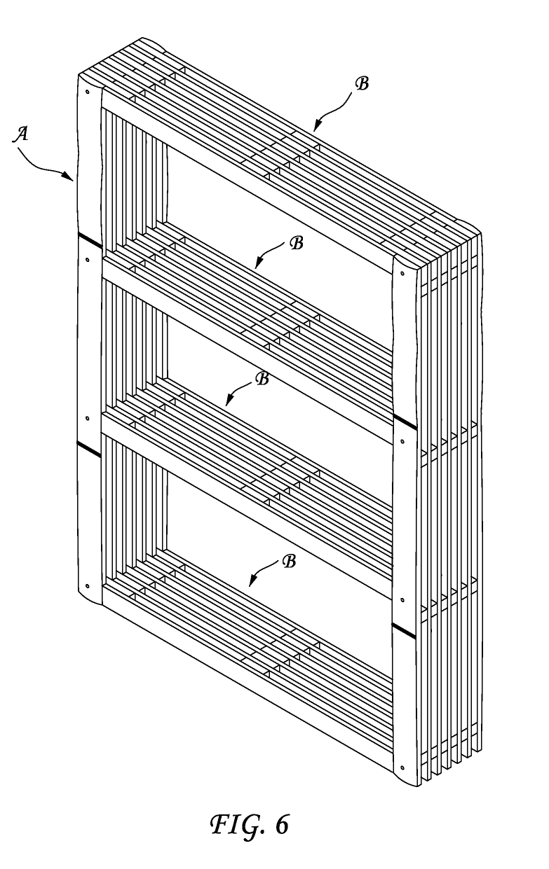

Referring to FIG. 6 and FIG. 5 again, multiple female bamboo frame bars A and multiple male bamboo frame bars B can be fastened together to constitute a rack.

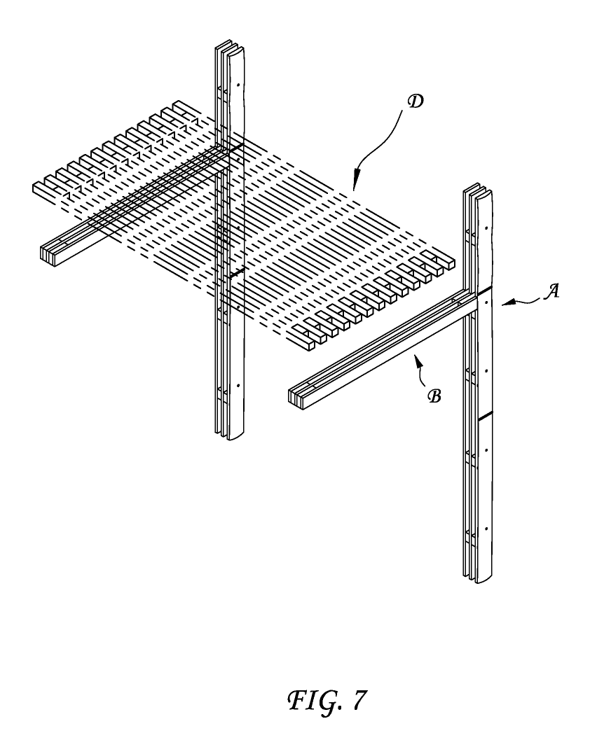

Referring to FIG. 7 and FIG. 5 again, one female bamboo frame bar A and one male bamboo frame bar B can be fastened together to constitute a support so that two supports can be used and affixed to a wall to support a bamboo grating panel D for holding storage or display items.

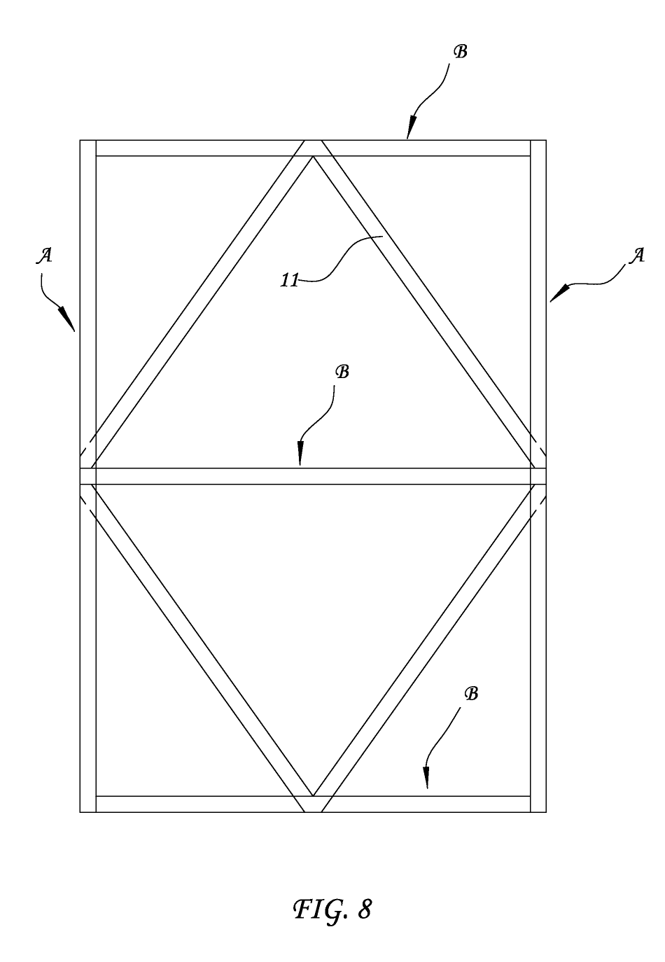

Referring to FIG. 8, female bamboo frame bars A and male bamboo frame bars B can be fastened together to constitute a rectangular open frame and a bamboo strip 11 may be obliquely connected between one female bamboo frame bar A and one male bamboo frame bar B to work as a brace.

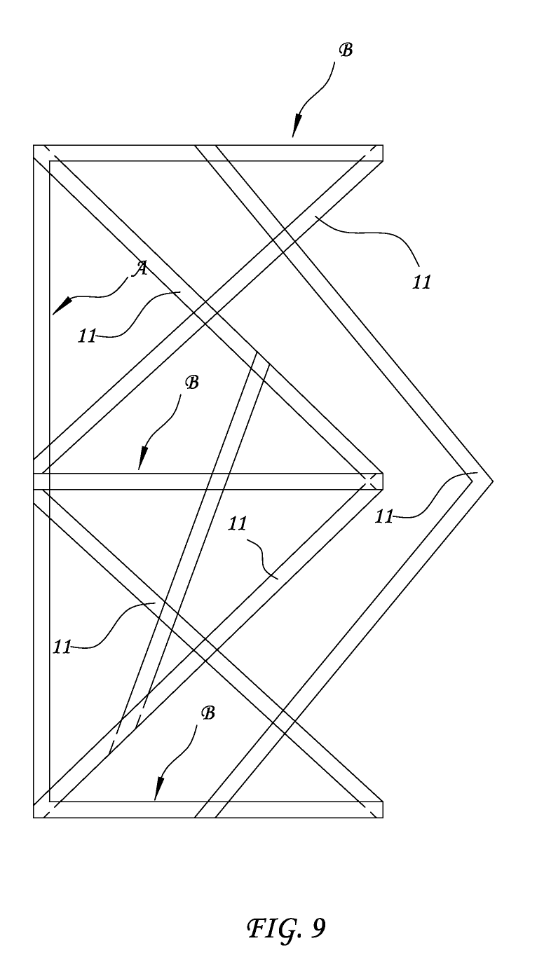

Referring to FIG. 9, three male bamboo frame bars B are respectively connected to one female bamboo frame bar A to constitute an E-shaped frame, and reinforcing bamboo strips 11 are fastened to the female bamboo frame bar A and the male bamboo frame bars B to reinforce the structural strength of the E-shaped frame.

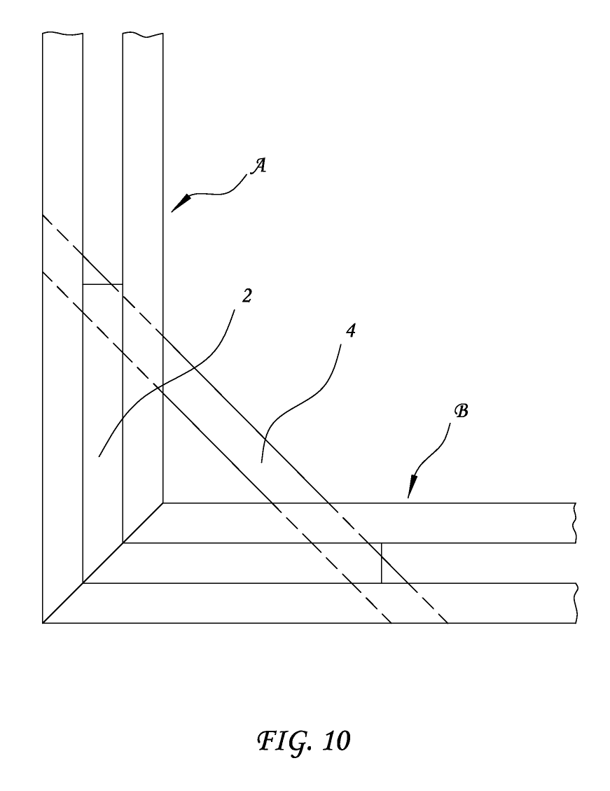

Referring to FIG. 10, two male bamboo frame bars B are respectively perpendicularly connected to two female bamboo frame bars A with bamboo blocks 2 set between the two male bamboo frame bars B and the two female bamboo frame bars A, forming an angle frame structure.

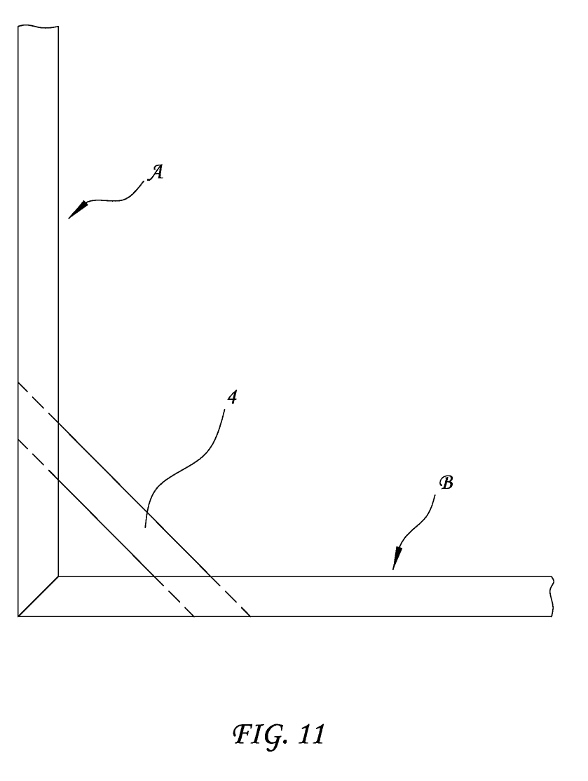

Referring to FIG. 11, a male bamboo frame bar B and a female bamboo frame bar A are fastened together to form an angle frame structure, and a reinforcing member 4 is obliquely connected between the female bamboo frame bar A and the male bamboo frame bar B to reinforce the strength of the angle frame structure.

Further, well-dried bamboo canes 1 can be trimmed and then cut along the length into bamboo strips 11, and then a number of bamboo strips 11 can be bonded to one another to form a solid high-strength frame bar for use as a leg member for furniture.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-7. (canceled)

8. A bamboo frame structure comprising:
two female bamboo frame bars each having a plurality of first bamboo strips arranged in parallel;
a plurality of transverse bamboo blocks set in between said first bamboo strips and defining a gap in between every two adjacent ones of said first bamboo strips and kept spaced from two distal ends of each of said first bamboo strips at a distance;
two male bamboo frame bars each having a plurality of second bamboo strips arranged in parallel;
a plurality of longitudinal bamboo blocks set in between said second bamboo strips and respectively protruding over two distal end of each of said second bamboo strips, a protruding part of said longitudinal bamboo blocks of each of said male bamboo frame bars being configured to be insertable into said gap in between said first bamboo strips of each of said female frame bars and connectable thereto with a screw thereby forming a rectangular bamboo open frame; and
a plurality of reinforcing bamboo strips obliquely connected to said female bamboo frame bars and said male bamboo frame bars.
